(19) United States
(12) Patent Application Publication
(10) Pub. No.: US 2025/0158554 A1
(43) Pub. Date: May 15, 2025

(54) MOTOR CONTROL DEVICE, HYBRID SYSTEM, MECHANICALLY AND ELECTRICALLY INTEGRATED UNIT, AND ELECTRIC VEHICLE SYSTEM

(71) Applicant: HITACHI ASTEMO, LTD., Ibaraki (JP)

(72) Inventors: Takafumi HARA, Tokyo (JP); Takaya TSUKAGOSHI, Hitachinaka-shi (JP); Shigehisa AOYAGI, Hitachinaka-shi (JP); Hideki MIYAZAKI, Hitachinaka-shi (JP)

(21) Appl. No.: 18/832,967

(22) PCT Filed: Apr. 21, 2023
(86) PCT No.: PCT/JP2023/016002

§ 371 Date: Jul. 25, 2024

(30) Foreign Application Priority Data
May 18, 2022 (JP) 2022-081763

(51) Int. Cl. H02P 27/12; B60L 15/20; H02P 21/22

(52) U.S. Cl. CPC H02P 27/12; H02P 21/22; B60L 15/20; H02P 2207/05

(57) ABSTRACT

This motor control device is connected to an inverter for converting DC power to AC power to output the AC power to a motor and controls the operation of the inverter in accordance with a torque command, thereby controlling the drive of the motor using the inverter. The motor control device comprises: a carrier wave generation unit that generates a carrier wave; a carrier frequency adjustment unit that adjusts a carrier frequency that is the frequency of the carrier wave; and a PWM control unit that performs pulse width modulation on a voltage command using the carrier wave and generates a PWM pulse signal for controlling the operation of the inverter. The carrier frequency adjustment unit adjusts the carrier frequency so that the carrier frequency when the motor performs entrainment drive becomes higher than the carrier frequency when the motor does not perform the entrainment drive.

### TECHNICAL FIELD

The present invention relates to a motor control device, a hybrid system, a mechanically and electrically integrated unit, and an electric vehicle system.

### BACKGROUND ART

A motor control device that controls the operation of an inverter that converts DC power into AC power, using a plurality of switching elements, and drives an AC motor with the AC power outputted from the inverter to control the motor has been known. Such a motor control device is widely used for controlling a motor in electric vehicles, such as railway vehicles and electric cars.

As a motor incorporated in an electric vehicle, a permanent magnet synchronous motor having a permanent magnet attached to a rotor is widely used. In an area where the load of the motor is small, so-called co-rotation drive of the motor occurs, which refers to a phenomenon that the rotor of the motor is caused to rotate by rotation of a motor drive shaft resulting from traveling of the electric vehicle. When the motor is in a state of co-rotation drive, the rotor of the motor is caused to rotate to generate an alternating magnetic field in a stator, and this alternating magnetic field causes a no-load iron loss (entrainment loss), which is a problem.

Regarding reduction of the iron loss of the motor, for example, a technique of PTL 1 is known. PTL 1 describes a control device for an AC motor, which control device calculates a current waveform for reducing the iron loss of the motor in advance by an electromagnetic field analysis and caries out control of current supply to the motor according to the calculated current waveform, thereby reducing the iron loss of the motor.

### CITATION LIST

### Patent Literature

PTL 1: JP 2008-72832 A

### SUMMARY OF INVENTION

### Technical Problem

Power loss that develops at the time of driving the motor mainly includes a switching loss by an inverter and an iron loss by the motor. These losses vary depending on the switching frequency of the inverter and the load state of the motor. However, this point is not taken into consideration for the control device described in PTL 1. As a result, the control device is not able to sufficiently reduce the power loss that develops at the time of driving the motor in both of a case where the motor is in a state of co-rotation drive and a case where the motor is not in the state of co-rotation drive.

### Solution to Problem

A motor control device according to one aspect of the present invention is connected to an inverter that converts DC power into AC power and that outputs the AC power to a motor, and controls operation of the inverter according to a torque instruction, thereby controlling drive of the motor, using the inverter. The motor control device includes: a carrier wave generation unit that generates a carrier wave; a carrier frequency adjustment unit that adjusts a carrier frequency that is a frequency of the carrier wave; and a PWM control unit that performs pulse width modulation of a voltage instruction, using the carrier wave, to generate a PWM pulse signal for controlling operation of the inverter. The carrier frequency adjustment unit adjusts the carrier frequency so that the carrier frequency in a case where the motor is in a state of co-rotation drive becomes higher than the carrier frequency in a case where the motor is not in the state of co-rotation drive.

A motor control device according to another aspect of the present invention is connected to an inverter that converts DC power into AC power and that outputs the AC power to a motor, and controls operation of the inverter according to a torque instruction, thereby controlling drive of the motor, using the inverter. When an absolute value of the torque instruction is equal to or smaller than a given threshold, the motor control device generates a PWM pulse signal for controlling operation of the inverter so that harmonic pulsation of a gap magnetic flux density between a stator and a rotor of the motor is suppressed.

A hybrid system according to the present invention includes: a motor control device; the inverter connected to the motor control device; the motor driven by the inverter; and an engine system connected to the motor.

A mechanically and electrically integrated unit according to the present invention includes: a motor control device; the inverter connected to the motor control device; the motor driven by the inverter; and a gear that transmits a rotational driving force of the motor. The motor, the inverter, and the gear are put together into an integrated structure.

An electric vehicle system according to the present invention includes: a motor control device; the inverter connected to the motor control device; and the motor driven by the inverter. The electric vehicle system travels by using a rotational driving force of the motor.

### Advantageous Effects of Invention

According to the present invention, power loss that develops at the time of driving the motor can be reduced sufficiently in both of the case where the motor is in the state of co-rotation drive and the case where the motor is not in the state of co-rotation drive.

### BRIEF DESCRIPTION OF DRAWINGS

FIG. 1 is an overall configuration diagram of a motor drive system including a motor control device according to an embodiment of the present invention.

FIG. 2 is a block diagram showing a functional configuration of the motor control device according to a first embodiment of the present invention.

FIG. 3 is a schematic diagram of a relationship between a motor loss, an inverter loss, and a system loss given by adding up the motor loss and the inverter loss.

FIG. 4 depicts an example of results of simulation of a current waveform.

FIG. 5 depicts a ratio between a motor loss and an inverter loss that make up a system loss.

FIG. 6 depicts an example of a relationship between the number of revolutions of a motor and the torque of the motor during traveling of a vehicle.

FIG. 7 depicts an example of a system loss that results when a carrier frequency is changed.

FIG. 8 is a flowchart showing a process by a carrier frequency adjustment unit according to a first embodiment of the present invention.

FIG. 9 depicts an example of carrier frequency adjustment according to the first embodiment of the present invention.

FIG. 10 depicts an example of a system loss calculation result in the case of conventional motor control and a system loss calculation result in the case of motor control to which the present invention is applied.

FIG. 11 depicts a relationship between a carrier wave signal in conventional motor control and current control and current instruction output that are performed in a microcomputer.

FIG. 12 depicts a relationship between a carrier wave signal in the motor control device of the present embodiment and current control and current instruction output that are performed in the microcomputer.

FIG. 13 is a block diagram showing a functional configuration of a motor control device according to a second embodiment of the present invention.

FIG. 14 is a block diagram of an instruction correction unit according to the second embodiment of the present invention.

FIG. 15 depicts an example of an iron loss for each time order that results when a d-axis current is applied to the motor.

FIG. 16 is a flowchart showing a process by the instruction correction unit, a switching unit, and the carrier frequency adjustment unit according to the second embodiment of the present invention.

FIG. 17 is a configuration diagram of a hybrid system according to a third embodiment of the present invention.

FIG. 18 is an external perspective view of a mechanically and electrically integrated unit according to a fourth embodiment of the present invention.

FIG. 19 is a configuration diagram of a hybrid car system according to a fifth embodiment of the present invention.

### DESCRIPTION OF EMBODIMENTS

### First Embodiment

A first embodiment of the present invention will hereinafter be described with reference to the drawings.

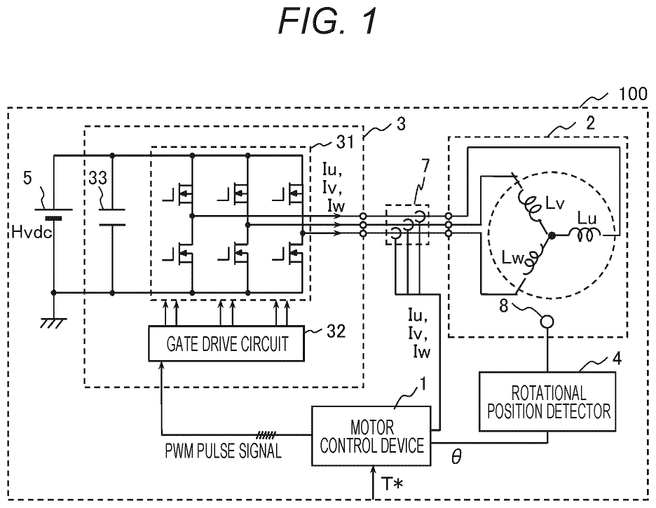

FIG. 1 is an overall configuration diagram of a motor drive system including a motor control device according to an embodiment of the present invention. In FIG. 1, a motor drive system 100 includes a motor control device 1, a permanent magnet synchronous motor (which will hereinafter be simply referred to as a “motor”) 2, an inverter 3, a rotational position detector 4, and a high-voltage battery 5.

The motor control device 1 controls the operation of the inverter 3, based on a torque instruction TX corresponding to a target torque a vehicle requests the motor 2 to generate, thereby generating a PWM pulse signal for controlling drive of the motor 2. The generated PWM pulse signal is outputted to the inverter 3. Details of the motor control device 1 will be described later.

The inverter 3 includes an inverter circuit 31, a gate drive circuit 32, and a smoothing capacitor 33. Based on the incoming PWM pulse signal from the motor control device 1, the gate drive circuit 32 generates gate drive signals for controlling switching elements included in the inverter circuit 31 and outputs the gate drive signals to the inverter circuit 31. The inverter circuit 31 includes pairs of switching elements corresponding respectively to pairs of an upper arm and a lower arm of a U phase, a V phase, and a W phase. These switching elements are each controlled by an incoming gate drive signal from the gate drive circuit 32. As a result, DC power supplied from the high-voltage battery 5 is converted into AC power, which is outputted to the motor 2. The smoothing capacitor 33 smooths the DC power supplied from the high-voltage battery 5 to the inverter circuit 31.

The motor 2, which is a synchronous motor caused to rotate by the AC power supplied from the inverter 3, includes a stator and a rotor. When the incoming AC power from the inverter 3 is applied to armature coils Lu, Lv, and Lw disposed on the stator, the motor 2 comes to carry three-phase AC currents Iu, Iv, and Iw, which generates armature magnetic flux in each armature coil. Then, an attractive force and a repulsive force are generated between the armature magnetic flux of each armature coil and magnetic flux of a permanent magnet disposed on the rotor. As a result, a torque is generated at the rotor, which is thus caused to rotate.

The motor 2 is fitted with a rotational position sensor 8 for detecting a rotational position θ of the rotor. The rotational position detector 4 calculates the rotational position θ from an incoming signal from the rotational position sensor 8. A result of calculation of the rotational position θ by the rotational position detector 4 is inputted to the motor control device 1, and is used in AC power phase control that the motor control device 1 carries out by generating a PWM pulse signal in accordance with the phase of an induced voltage of the motor 2.

It is preferable that a resolver composed of an iron core and a winding be used as the rotational position sensor 8, but using a magnetoresistive element sensor, such as a GMR sensor, or a sensor composed of a Hall element is no problem at all. The rotational position detector 4 may estimate the rotational position θ by not using the incoming signal from the rotational position sensor 8 but using the three-phase AC currents Iu, Iv, and Iw flowing through the motor 2 or three-phase AC voltages Vu, Vv, and Vw applied from the inverter 3 to the motor 2.

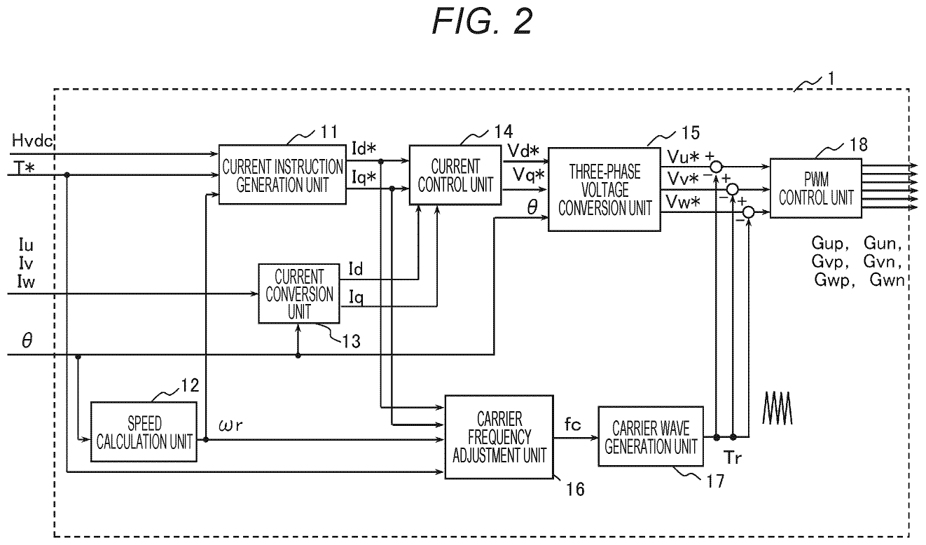

A current detection unit 7 is disposed between the inverter 3 and the motor 2. The current detection unit 7 detects the three-phase AC currents Iu, Iv, and Iw (U-phase AC current Iu, V-phase AC current Iv, and W-phase AC current Iw) flowing through the motor 2. The current detection unit 7 is composed of, for example, a Hall current sensor or the like. Results of detection of the three-phase AC currents Iu, Iv, and Iw by the current detection unit 7 are inputted to the motor control device 1, and are used for PWM pulse signal generation performed by the motor control device 1. FIG. 2 shows an example in which the current detection unit 7 is made up of three current detectors. In another example, however, two current detectors are used and the AC current of the remaining one phase may be calculated from the fact that the sum of the three-phase AC currents Iu, Iv, and Iw s zero. In still another example, a pulsed DC current flowing from the high-voltage battery 5 into the inverter 3 is detected by a shunt resistance or the like interposed between the smoothing capacitor 33 and the inverter 3, and the three-phase AC currents Iu, Iv, and Iw may be determined based on this DC current and the three-phase AC voltages Vu, Vv, and Vw applied from the inverter 3 to the motor 2.

The details of the motor control device 1 will then be described. FIG. 2 is a block diagram showing a functional configuration of the motor control device 1 according to the first embodiment of the present invention. In FIG. 2, the motor control device 1 includes a current instruction generation unit 11, a speed calculation unit 12, a current conversion unit 13, a current control unit 14, a three-phase voltage conversion unit 15, a carrier frequency adjustment unit 16, a carrier wave generation unit 17, and a PWM control unit 18, which are functional blocks. The motor control device 1 is composed of, for example, a microcomputer, and this microcomputer executes given programs to implement these functional blocks. Alternatively, some or all of these functional blocks may be provided as hardware circuits, such as a logic IC or an FPGA.

The current instruction generation unit 11 calculates a d-axis current instruction Id* and a q-axis current instruction Iq*, based on the input torque instruction T* and a voltage Hvdc of the high-voltage battery 5. In this case, the d-axis current instruction Id* and the q-axis current instruction Iq that correspond to the torque instruction T* are obtained, using, for example, a preset current instruction map, a formula, or the like.

The speed calculation unit 12 calculates a motor rotating speed or representing the rotating speed (number of revolutions) of the motor 2, from time-dependent changes in the rotational position θ. The motor rotating speed or is expressed in the form of either an angular speed (rad/s) or the number of revolutions (rpm). These angular speed and the number of revolutions may be converted into each other to be used as the motor rotating speed or.

The current conversion unit 13 carries out dq conversion of the three-phase AC currents Iu, Iv, and Iw detected by the current detection unit 7, based on the rotational position θ obtained by the rotational position detector 4, to calculate a d-axis current value Id and a q-axis current value Iq.

Based on deviations between the d-axis current instruction Id* and q-axis current instruction Iq* outputted from the current instruction generation unit 11 and the d-axis current value Id and q-axis current value Iq outputted from the current conversion unit 13, the current control unit 14 calculates the d-axis voltage instruction Vd* and the q-axis voltage instruction Vq* that correspond to the torque instruction T* so that these current instructions and current values match each other. In this case, for example, by such a control method as PI control, the d-axis voltage instruction Vd* corresponding to the deviation between the d-axis current instruction Id* and the d-axis current value Id and the q-axis voltage instruction Vq* corresponding to the deviation between the q-axis current instruction Iq* and the q-axis current value Iq are obtained in each of given calculation cycles Tv.

The three-phase voltage conversion unit 15 carries out three-phase conversion of the d-axis voltage instruction Vd* and the q-axis voltage instruction Vq* that are calculated by the current control unit 14, based on the rotational position θ obtained by the rotational position detector 4, to calculate three-phase voltage instructions Vu*, Vv*, and Vw* (U-phase voltage instruction value Vu*, V-phase voltage instruction value Vv*, and W-phase voltage instruction value Vw*). Hence the three-phase voltage instructions Vu*, Vv*, and corresponding to the torque instruction T* are generated.

The carrier frequency adjustment unit 16 adjusts a carrier frequency fc, which is the frequency of a carrier wave used to generate the PWM pulse signal, based on the rotating speed or obtained by the speed calculation unit 12. At this time, the carrier frequency adjustment unit 16 determines whether the motor 2 is in a state of co-rotation drive, based on the torque instruction T* or the d-axis current instruction Id* and q-axis current instruction Iq* generated by the current instruction generation unit 11. When determining that the motor 2 is in the state of co-rotation drive, the carrier frequency adjustment unit 16 adjusts the carrier frequency fc so that it becomes higher than the carrier frequency fc in a case where the motor 2 is not in the state of co-rotation drive. As a result, power loss that occurs at the time of driving the motor 2 is reduced in both of a case where the motor 2 is in the state of co-rotation drive and a case where the motor 2 is not in the state of co-rotation drive. Details of the carrier frequency adjustment unit 16 will be described later.

The carrier wave generation unit 17 generates a carrier wave signal (triangular wave signal) Tr, based on carrier frequency fc calculated by carrier frequency adjustment unit 16.

Using the carrier wave signal Ir outputted from the carrier wave generation unit 17, the PWM control unit 18 carries out pulse width modulation of the three-phase voltage instructions Vu*, Vv*, and Vw* outputted from the three-phase voltage conversion unit 15 to generate PWM pulse signals for controlling the operation of the inverter 3. Specifically, based on a result of comparison between the three-phase voltage instructions Vu*, Vv*, and Vw* outputted from the three-phase voltage conversion unit 15 and the carrier wave signal Tr outputted from the carrier wave generation unit 17, pulse voltages of the U phase, the V phase, and the W phase are generated. Then, based on the generated pulsed voltages, PWM pulse signals for the switching elements of the three phases of the inverter 3 are generated. At this time, PWM pulse signals Gup, Gvp, and Gwp for the upper arms of the three phases are logically inverted to generate PWM pulse signals Gun, Gvn, and Gwn for the lower arms. The PWM pulse signals generated by the PWM control unit 18 are outputted from the motor control device 1 to the gate drive circuit 32 of the inverter 3, which gate drive circuit 32 converts the PWM pulse signals into gate drive signals. As a result, the switching elements of the inverter circuit 31 switch on/off in a controlled manner, which adjusts an output voltage from the inverter 3.

The operation of the carrier frequency adjustment unit 16 in the motor control device 1 will then be described. As described above, the carrier frequency adjustment unit 16 determines whether the motor 2 is in the state of co-rotation drive, based on the torque instruction T* or the d-axis current instruction Id* and the q-axis current instruction Iq* that are generated by the current instruction generation unit 11. When determining that the motor 2 is in the state of co-rotation drive, the carrier frequency adjustment unit 16 adjusts the carrier frequency fc so that it becomes higher than the carrier frequency fc in a case where the motor 2 is not in the state of co-rotation drive. In this manner, the frequency of the carrier wave signal Tr generated by the carrier wave generation unit 17 is sequentially controlled in accordance with the carrier frequency fc. This allows the PWM control unit 18 to generate the PWM pulse signal so that the power loss that occurs at the time of driving the motor 2 is reduced in both of the case where the motor 2 is in the state of co-rotation drive and the case where the motor 2 is not in the state of co-rotation drive.

Loss caused by the motor 2 and the inverter 3 that make up the motor drive system 100 will hereinafter be described. Motor loss caused by the motor 2 includes two major losses: copper loss and iron loss. The copper loss is a loss caused by a current flow in a coil copper wire connected to the stator, and increases in proportion to the square of the amplitude of the current. This copper loss is not affected by the pitch width of the PWM pulse signal outputted from the motor control device 1 to the inverter 3. The iron loss, on the other hand, is a loss caused by fluctuations in magnetic flux flowing through the stator and the rotor. It is a widely known fact that as the pitch width of the PWM pulse signal gets finer, fluctuations in the magnetic flux generated by the coil copper wire of the stator gets lighter to reduce the iron loss.

Inverter loss caused by the inverter 3 includes two major losses: conduction loss and switching loss. The conduction loss is a loss that occurs when each switching element is supplied with current, and increases in proportional to a current flowing through the inverter 3. The switching loss, on the other hand, is a loss caused by the on/off action of each switching element. It is a widely known fact that as the pitch width of the PWM pulse signal gets finer, the number of times of the switching element's switching on/off gets larger to increase the switching loss.

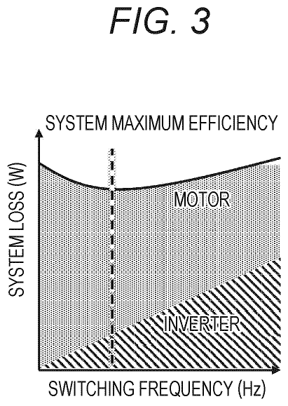

FIG. 3 is a schematic diagram of a relationship between the motor loss, the inverter loss, and the system loss of the motor drive system 100, the system loss being given by adding up the motor loss and the inverter loss. In FIG. 3, the vertical axis represents the magnitude of each loss, and the horizontal axis represents the switching frequency that determines the pitch width of the PWM pulse signal, that is, the carrier frequency fc. FIG. 3 demonstrates that as the switching frequency is increased, the motor loss decreases but at the same time, the inverter loss increases, thus leading to an understanding that these losses have a trade-off relationship. For this reason, according to the conventional motor control method, it is a common approach that the carrier frequency fc is adjusted toward a minimum point (system maximum efficiency point) at which the system loss is minimized.

However, the inventors of the present invention have found that the above-described trade-off relationship does not always hold depending on the torque and the number of revolutions of the motor. This point will be described in detail below.

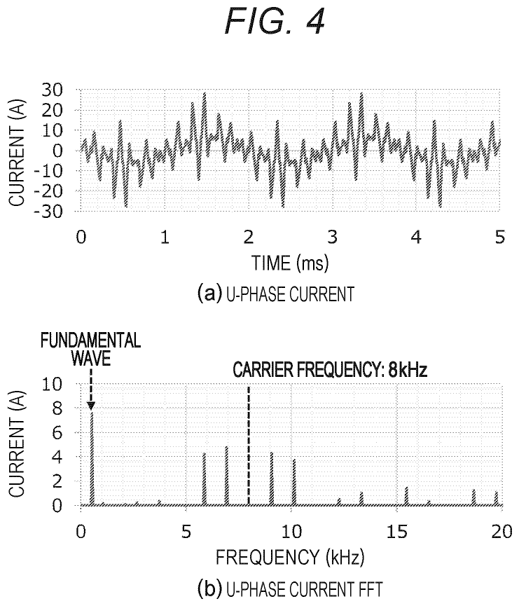

FIG. 4 depicts an example of results of simulation of a current waveform that is generated when a permanent magnet synchronous motor of an 8-pole machine is driven at 8,000 r/min, using a PWM pulse signal with the carrier frequency fc set to 8 kHz. FIG. 4 (a) depicts an example of a U-phase current waveform obtained by the simulation, and FIG. 4 (b) depicts a result of an FFT (Fast Fourier Transformation) analysis of the frequency components of the current waveform of FIG. 4 (a). These figures demonstrate that even if the amplitude of a fundamental wave corresponding to a current instruction is several amperes, which is not so large, current distortion by frequency components in the vicinity of the carrier frequency fc (current distortion caused by time harmonics) occurs with an amplitude as large as the amplitude of the fundamental wave, thus leading to an understanding that fluctuations in the current waveform gets larger.

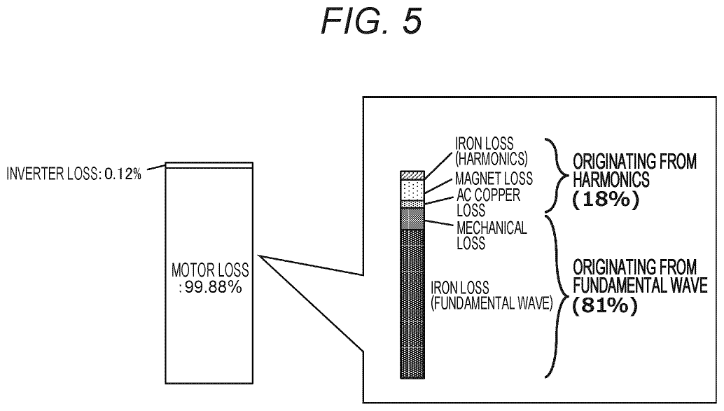

FIG. 5 depicts a ratio between the motor loss and the inverter loss that make up the system loss under the motor drive conditions shown in FIG. 4. FIG. 5 shows an example in which the motor loss and the inverter loss, which arise in the current waveform shown in FIG. 4 (a), and the system loss, which is given by adding up the motor loss and the inverter loss, are each calculated by an electromagnetic field analysis. It is understood from FIG. 5 that in an area where a current flowing through the motor is about several amperes, which is not so large, the motor loss is a major loss, accounting for 99.88% of the system loss, while the inverter loss is the minimum, accounting for 0.12% of the same. Further, a detailed analysis of the breakdown of the motor loss gives an understanding that various motor losses originating from harmonics (harmonic iron loss, magnet loss, AC copper loss) account for 18% of the entire motor loss. It gives an additional understanding that these motor losses originating from harmonics (harmonic iron loss, magnet loss, AC copper loss) are the result of the above-mentioned current distortion caused by time harmonics.

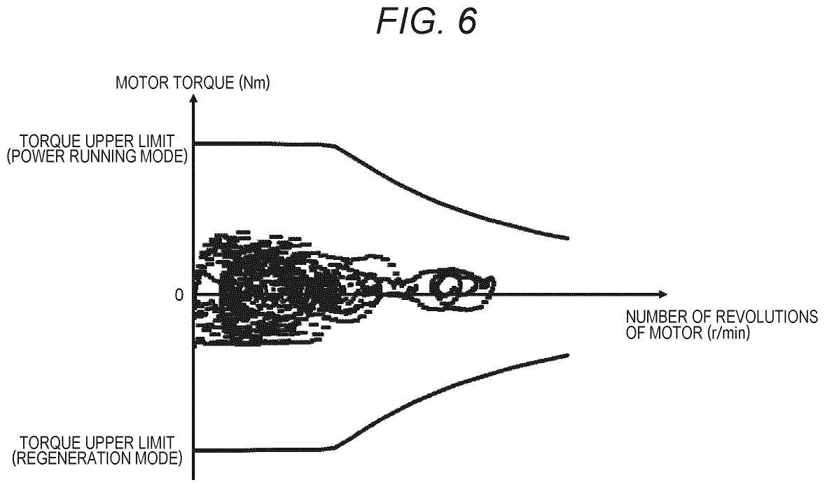

An example of a motor operation during traveling of the vehicle will then be described below. FIG. 6 depicts an example of a relationship between the number of revolutions of the motor and the torque of the motor during traveling of the vehicle. FIG. 6, which is an NT characteristic diagram with the horizontal axis representing the number of revolutions of the motor (r/min) and the vertical axis representing the torque of the motor (Nm), shows a relationship between the number of revolutions of the motor and the torque of the motor that holds when the vehicle equipped with the motor drive system 100 travels in a worldwide harmonized light vehicle test cycles (WLTC) mode. FIG. 6 gives a confirmation that many operation points of the motor torque in the WLIC traveling mode exist within a certain range around a torque value 0, that is, in an area where a motor load is equal to or smaller than a certain value. In particular, in an area near the torque value 0, the motor 2 is in the state of co-rotation drive, which leads to an understanding that many torque operating points exist in this area where the motor 2 is in the state of co-rotation drive.

In general, the larger the torque of the motor is, the bigger the modulation rate becomes. From what is shown in FIG. 6, therefore, it can be said that many operation points of the motor torque in the WLIC traveling mode exist in an area where the modulation factor stays within a certain range. The modulation rate is a parameter representing a ratio between a DC voltage and an AC voltage, and is also referred to as a voltage utilization rate. The modulation rate is calculated by the following equation (1), based on the d-axis voltage Vd, the q-axis voltage Vq, and the voltage Hvdc of the high-voltage battery 5.

$$H = √ ( {Vd}^{2} + {Vq}^{2} ) / Hvdc \qquad ( 1 )$$

As described above, in the WLIC traveling mode, an area where the absolute value of the motor torque is equal to or smaller than a certain value (the modulation rate is equal to or smaller than 1.25) occupies over the half of the entire area, and this area includes many areas where the motor 2 is in the state of co-rotation drive. When the rotating speed of the motor 2 is equal to or higher than a certain value, to prevent a case where the voltage Hvdc applied from the high-voltage battery 5 to the inverter 3 is saturated by an induced voltage generated by the rotor magnet, a weak field current needs to be supplied to the motor 2. However, as it can be seen from FIG. 6, the motor torque as a whole is small in the WLIC traveling mode, and, for this reason, supply of the weak field current is not done in many time zones during traveling of the vehicle.

With regard to this issue, according to this embodiment, when the motor 2 is in the state of co-rotation drive, remedy of time-harmonics-caused distortion through the increased carrier frequency fc is carried out within a range in which the inverter loss does not increase. As described above, because the modulation rate does not exceed 1.25 in many cases during traveling of the vehicle, increasing the carrier frequency fc when the motor 2 is in the state of co-rotation drive offers a greater effect in reducing the system loss.

It should be noted that in the motor control device 1 of this embodiment, the characteristics of each component of the motor 2 are selected so that when the motor 2 runs at the maximum rotating speed, an induced voltage induced at each armature coil of the stator does not exceed the withstand voltage of the switching element of the inverter 3. In other words, the motor control device 1 of this embodiment controls driving of the motor 2 such that the induced voltage generated by the rotation of the motor 2 remains smaller than the withstand voltage of the switching element of the inverter 3.

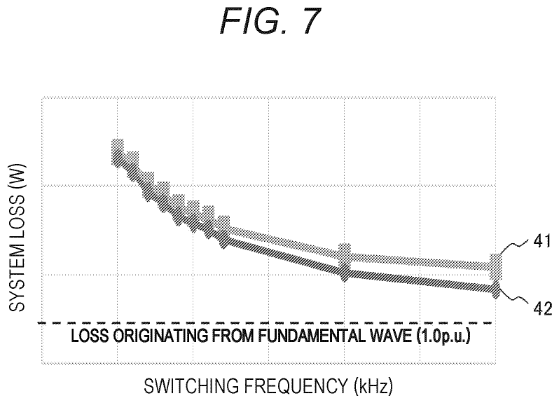

FIG. 7 depicts an example of the system loss (the sum of the motor loss and the inverter loss) that results when the carrier frequency fc is changed. FIG. 7 shows an example of a relationship between the switching frequency and the system loss that holds when the carrier frequency fc is changed under the same motor drive conditions as shown in FIG. 4. In FIG. 7, a graph 41 indicates an example of a relationship between the switching frequency and the system loss that holds when an insulated gate bipolar transistor (IGBT) is used as the switching element, and a graph 42 indicates an example of a relationship between the switching frequency and the system loss that holds when a silicon carbide (SiC) semiconductor is used as the switching element.

When the motor 2 is in the state of co-rotation drive, the inverter loss is the minimum, as mentioned with reference to FIG. 5, and therefore the minimum point at which the highest system efficiency is achieved, which is shown in FIG. 3, does not exist. As a result, as shown in the graphs 41 and 42 of FIG. 7, the system loss monotonously decreases as the switching frequency increases. In this manner, the inventors of the present invention have found that the system loss in the case of the motor load being relatively small decreases monotonically in relation to the carrier frequency fc. In other words, when the motor 2 is in the state of co-rotation drive, harmonics-caused motor loss can be reduced at the maximum level by increasing the carrier frequency fc as much as possible within a range corresponding to limitations by the process load of the microcomputer serving as the motor control device 1 and limitations by the capacity of a gate power supply (not illustrated) that supplies power to the gate drive circuit 32 of the inverter 3.

A turning point to determine whether the system loss curve becomes the monotonously decreasing curve shown in the graphs 41 and 42 or the curve with the minimum point at which the highest system efficiency is achieved is determined by the motor torque or current. It is necessary, therefore, to determine a torque condition and a current condition for switching control of the carrier frequency fc by performing simulation and actual machine verification in advance through an electromagnetic field analysis. The determined torque condition and current condition are used as a threshold, and whether or not to increase the carrier frequency fc is determined depending on whether the torque or current is smaller or larger than the threshold. By this process, the power loss that develops at the time of driving the motor can be sufficiently reduced in both of the case where the motor 2 is in the state of co-rotation drive and the case where the motor 2 is not in the state of co-rotation drive.

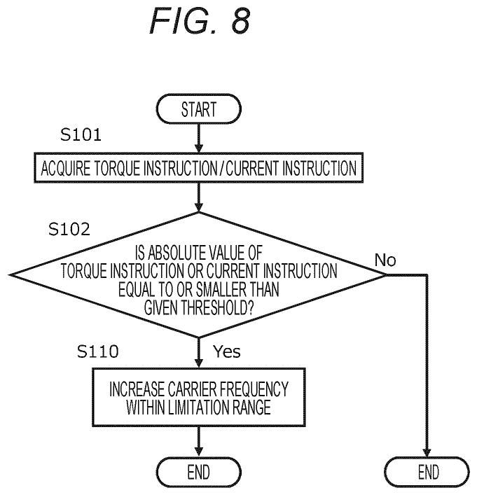

FIG. 8 is a flowchart showing a process by the carrier frequency adjustment unit 16 according to the first embodiment of the present invention. The process shown in the flowchart of FIG. 8 is carried out by the carrier frequency adjustment unit 16, for example, in every given process cycle.

At step S101, a value of the torque instruction T* or values of the d-axis current instruction Id* and q-axis current instruction Iq* generated by the current instruction generation unit 11 are acquired. Both of these instructions or only one of them are acquired.

At step S102, the absolute value of the torque instruction T* or the current instruction (d-axis current instruction Id* and q-axis current instruction Iq*) acquired at step S101 is compared with a given threshold, and whether or not the absolute value of the torque instruction T* or that of the current instruction is equal to or smaller than the threshold is determined. At this step, when the torque instruction T* is acquired at step S101, the absolute value of the torque instruction T* is compared with the threshold for the torque instruction, and when the current instruction is acquired, the absolute value of the current instruction is compared with the threshold for the current instruction. As mentioned above, the threshold used for the determination at step S102 is determined based on the result of simulation or experiment conducted in advance through the electromagnetic field analysis, and is saved by the motor control device 1.

In the process of step S102, when the absolute value of the torque instruction T* or that of the current instruction is found equal to or smaller than the threshold, it is determined that the motor 2 is in the state of co-rotation drive, in which case the process flow proceeds to step S110. When the absolute value of the torque instruction T* or that of the current instruction is found larger than the threshold, on the other hand, it is determined that the motor 2 is not in the state of co-rotation drive, in which case the process shown in the flowchart of FIG. 8 ends. In this case, the carrier frequency adjustment unit 16 adjusts the carrier frequency fc, based on the rotating speed or, in the same manner as does in normal synchronous PWM control.

At step S110, the carrier frequency fc is increased within a given limitation range with respect to the carrier frequency fc in the normal synchronous PWM control. Thus, the carrier frequency fc is adjusted so that the carrier frequency fc in the case where the motor 2 is in the state of co-rotation drive becomes higher than the carrier frequency fc in the case where the motor 2 is not in the state of co-rotation drive. As a result, when the absolute value of the torque instruction T* or the current instruction is equal to or smaller than the given threshold, the PWM control unit 18 can generate a PWM pulse signal for controlling the operation of the inverter 3 so that harmonic pulsation of the gap magnetic flux density between the stator and the rotor of the motor 2 is suppressed. The limitation range of the carrier frequency fc is saved by the motor control device 1, the limitation range, as mentioned above, being determined based on, for example, the process load of the microcomputer serving as the motor control device 1 and on the capacity of the gate power supply that supplies power to the gate drive circuit 32 of the inverter 3.

After adjustment of the carrier frequency fc is done at step S110, the process shown in the flowchart of FIG. 8 ends.

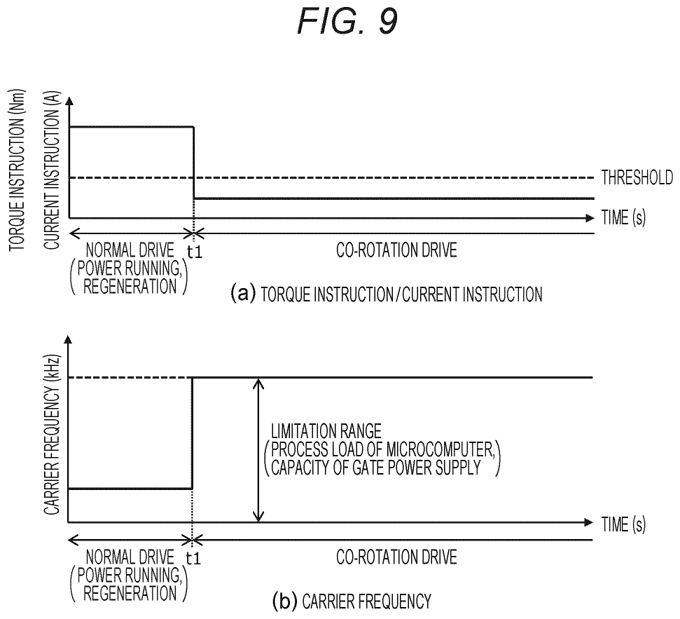

FIG. 9 depicts an example of the carrier frequency adjustment according to the first embodiment of the present invention. FIG. 9 (a) is a chart showing an example of a state of time-dependent change of the torque instruction T* or the current instruction, the chart having the horizontal axis representing time and the vertical axis representing the absolute value of the torque instruction T* or that of the current instruction. FIG. 9 (b) is a chart showing an example of a state of time-dependent change of the carrier frequency fc that results after the carrier frequency fc is adjusted for the case of FIG. 9 (a), the chart having the horizontal axis representing time and the vertical axis representing the carrier frequency fc.

As shown in FIG. 9 (a), the motor 2 is normally driven until time t1. In this period, the absolute value of the torque instruction T* or that of the current instruction is relatively large. In a period to follow time t1, on the other hand, the motor 2 is in the state of co-rotation drive, and the absolute value of the torque instruction T* or that of the current instruction in this period is smaller than the same in the normal drive period and is smaller than the given threshold. As a result, in the period to follow time t1 in which the motor 2 is in the state of co-rotation drive, the carrier frequency fc changes so that it becomes higher than the carrier frequency fc in the normal drive period lasting up to time t1 within the given limitation range, as shown in FIG. 9 (b).

When the carrier frequency fc is increased all at once at time t1, an amount of control of the motor 2 is changed sharply in response. This results in a sharp change in the drive status of the motor 2, which may cause vibration or noise. To avoid this, when the carrier frequency fc is changed in response to a change from the state of normal drive to the state of co-rotation drive, an upper limit may be set for the change width of the carrier frequency fc such that a rate of change of the carrier frequency fc per unit time is equal to or smaller than a given value.

By carrying out the operations as described above, in both of the case where the motor 2 is in the state of co-rotation drive and the case where the motor 2 is not in the state of co-rotation drive, the motor control device 1 of this embodiment can suppress the motor loss originating from harmonics (harmonic iron loss, magnet loss, AC copper loss) at the motor 2 while suppressing an increase in the inverter loss caused by an increase in the switching frequency of the inverter 3. Hence the system loss can be reduced.

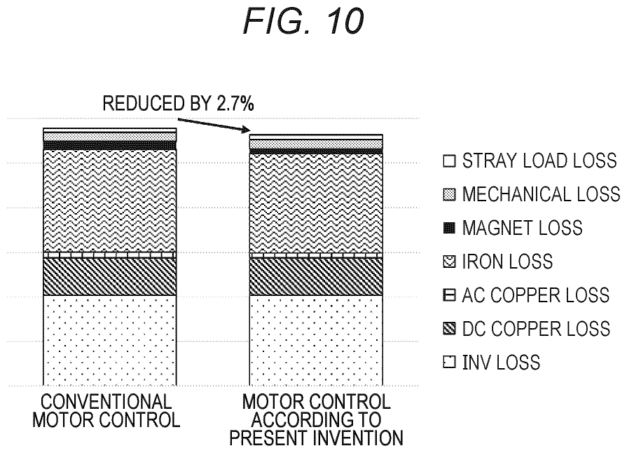

FIG. 10 depicts an example of a system loss calculation result in the case of conventional motor control to which the present invention is not applied and a system loss calculation result in the case of motor control to which the present invention is applied. The example of FIG. 10 shows system loss calculation results in a case where a traveling pattern of the vehicle is a pattern of the WLIC mode.

It can be understood from FIG. 10 that the motor control to which the present invention is applied can reduce the system loss in the case of the conventional motor control by 2.7%.

Next, a method for reducing the process load of the microcomputer according to this embodiment will hereinafter be described.

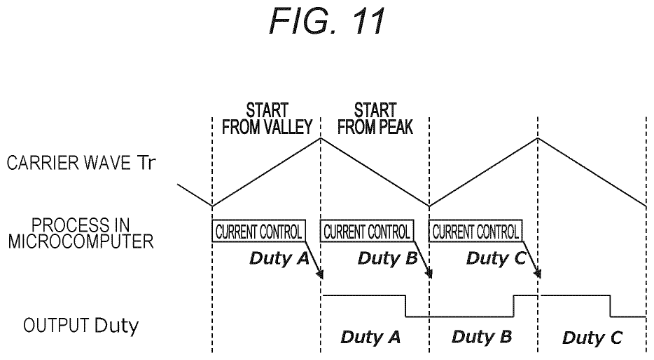

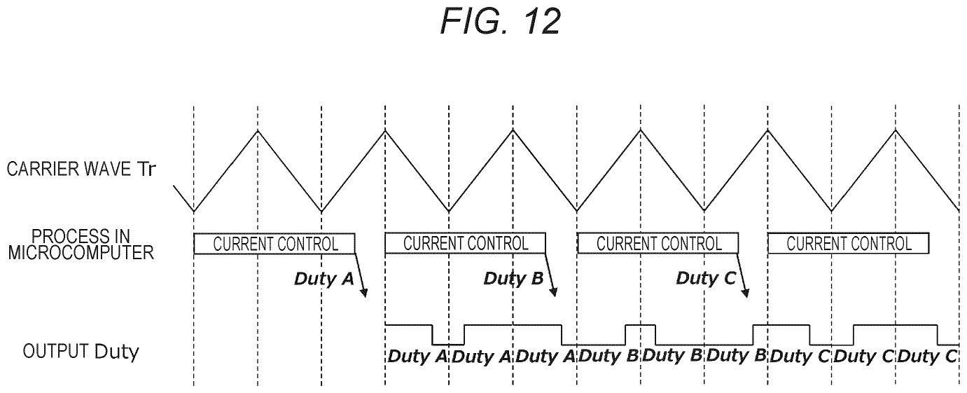

To minimize the system loss during the co-rotation drive, the motor control device 1 of this embodiment, as described above, needs to make the carrier frequency fc as high as possible within the limitation range corresponding to the process load of the microcomputer and the capacity of the gate power supply, thereby increasing the switching frequency. For that end, reducing the process load of the microcomputer as much as possible is desirable. Hereinafter, an example of a method of reducing the process load of the microcomputer in the motor control device 1 of this embodiment will be described with reference to FIGS. 11 and 12.

FIG. 11 depicts a relationship between a carrier wave signal Tr in the conventional motor control and current control and current instruction output that are performed in the microcomputer serving as the motor control device 1. In the conventional motor control, for example, current control in the microcomputer is started at each of a peak portion (a point at which rising turns to falling) and a valley portion (a point at which falling turns to rising) of the carrier wave signal Tr, and a voltage instruction (d-axis voltage instruction Vd* and q-axis voltage instruction Vq*) with a calculated duty is outputted in a period of peak portion or valley portion of the carrier wave signal Tr, the period corresponding to the next current control period. As a result, a PWM pulse signal with a fine pitch width and few time harmonics is generated.

However, according to the conventional motor control method shown in FIG. 11, for example, when the carrier frequency fc is 20 kHz, an interval between current control start points is 25 μs. In this case, the process load of the microcomputer for current control turns out to be relatively large, which raises a problem that a time spent for other processes is reduced.

FIG. 12 depicts a relationship between the carrier wave signal Tr in the motor control device 1 of this embodiment and current control and current instruction output that are performed in the microcomputer serving as the motor control device 1. The motor control device 1 of this embodiment, for example, starts current control in the microcomputer at a rate of once per three periods of peak portions and valley portions of the carrier wave signal Tr, as shown in FIG. 12. Then, a voltage instruction (d-axis voltage instruction Vd* and q-axis voltage instruction Vq*) with a calculated duty is repeatedly outputted in a period of the carrier wave signal Tr that corresponds to the next current control period, that is, in a period of three consecutive peak and valley portions. In this manner, the cycle of current control and the cycle of the carrier wave signal Tr are separated from each other. This makes it possible to generate a PWM pulse signal with a fine pitch width and few time harmonics while reducing the process load of the microcomputer for current control.

FIG. 12 shows the example in which current control in the microcomputer is carried out at the rate of once per three periods of peak portions and valley portions of the carrier wave signal Tr. However, the current control may be carried out at a different rate. If a calculation cycle of the voltage instruction made by the current control unit 14 is longer than at least half the cycle of the carrier wave signal Tr, that is, the interval between the peak point and the valley point, the above effect can be achieved. In other words, the carrier frequency adjustment unit 16 adjusts the carrier frequency fc in the case where the motor 2 is in the state of co-rotation drive so that the calculation cycle of voltage instruction made by the current control unit 14 is longer than half the cycle of the carrier wave signal Tr, thereby reducing the process load for current control and further increasing the switching frequency. When the microcomputer has an ample processing capability, adopting the motor control method shown in FIG. 12 is not always necessary and the conventional motor control method shown in FIG. 11 may be adopted.

The above-described first embodiment of the present invention offers the following effects.

(1) The motor control device 1 is connected to the inverter 3 that converts DC power into AC power and that outputs the AC power to the motor 2, and controls the operation of the inverter 3 according to the torque instruction T*, thereby controlling drive of the motor 2, using the inverter 3. The motor control device 1 includes the carrier wave generation unit 17 that generates the carrier wave signal Tr, the carrier frequency adjustment unit 16 that adjusts the carrier frequency fc that is the frequency of the carrier wave, and the PWM control unit 18 that carries out pulse width modulation of the three-phase voltage instructions Vu*, Vv*, and Vw*, using the carrier wave signal Tr, to generate the PWM pulse signal for controlling the operation of the inverter 3. The carrier frequency adjustment unit 16 adjusts the carrier frequency fc so that the carrier frequency fc in the case where the motor 2 is in the state of co-rotation drive becomes higher than the carrier frequency fc in the case where the motor 2 is not in the state of co-rotation drive (step S110). Because of this configuration, the power loss that develops at the time of driving the motor can be reduced sufficiently in both of the case where the motor 2 is in the state of co-rotation drive and the case where the where the motor 2 is not in the state of co-rotation drive.

(2) The carrier frequency adjustment unit 16 compares the absolute value of the torque instruction T* with the given threshold (step S102), and when the absolute value of the torque instruction T* is equal to or smaller than the threshold, determines that the motor 2 is in the state of co-rotation drive (step S102: Yes). Because of this process, whether the motor 2 is in the state of co-rotation drive can be determined easily.

(3) The threshold is determined based on the result of an electromagnetic field analysis simulation or an experiment conducted in advance. This allows setting a proper threshold.

(4) The carrier frequency fc in the case where the motor 2 is in the state of co-rotation drive is determined based on at least either the process load of the motor control device 1 or the capacity of the gate power supply that supplies power to the gate drive circuit 32 included in the inverter 3. Because of this process, the carrier frequency fc in the case where the motor 2 is in the state of co-rotation drive can be increased within a possible range.

(5) The motor control device 1 controls drive of the motor 2 such that an induced voltage generated by the rotation of the motor 2 remains smaller than the withstand voltage of the switching element of the inverter 3. Because of this process, even when the motor 2 is caused to rotate at high speed, an accident that the switching element of the inverter 3 is destroyed by the induced voltage can be prevented.

(6) The motor control device 1 includes the current control unit 14 that calculates the d-axis voltage instruction Vd* and the q-axis voltage instruction Vq* in every given calculation cycle. The carrier frequency adjustment unit 16 can adjust the carrier frequency fc in the case where the motor 2 is in the state of co-rotation drive so that the calculation cycle of voltage instruction by the current control unit 14 is longer than half the cycle of the carrier wave signal Tr. In this configuration, when the motor control device 1 is provided as the microcomputer, the PWM pulse signal with a fine pitch width and few time harmonics can be generated as the process load of the microcomputer for current control is reduced.

(7) The carrier frequency adjustment unit 16 may adjust the carrier frequency fc so that the rate of change of the carrier frequency fc is equal to or smaller than the given value. This prevents a case where when the drive state of the motor 2 is switched from the state of normal drive to the state of co-rotation drive, vibration or noise is generated.

(8) The motor control device 1 is connected to the inverter 3 that converts DC power into AC power and that outputs the AC power to the motor 2, and controls the operation of the inverter 3 according to the torque instruction T*, thereby controlling drive of the motor 2, using the inverter 3. When the absolute value of the torque instruction T* is equal to or smaller than the given threshold, the motor control device 1 generates a PWM pulse signal for controlling the operation of the inverter 3 so that the harmonic pulsation of the gap magnetic flux density between the stator and the rotor of the motor 2 is suppressed. Because of this configuration, in the case where the motor 2 is in the state of co-rotation drive, the power loss that develops at the time of driving the motor can be reduced.

### Second Embodiment

A second embodiment of the present invention will then be described with reference to drawings. In the above first embodiment, with focus placed on the fact that the inverter loss is small when the motor 2 is in the state of co-rotation drive, the motor control method of increasing the carrier frequency fc to reduce time harmonics and therefore reduce the motor loss (magnet loss, AC copper loss, iron loss) originating from harmonics, thereby reducing the system loss has been described. In the second embodiment, a motor control method by which iron loss during weak field control is also reduced will be described.

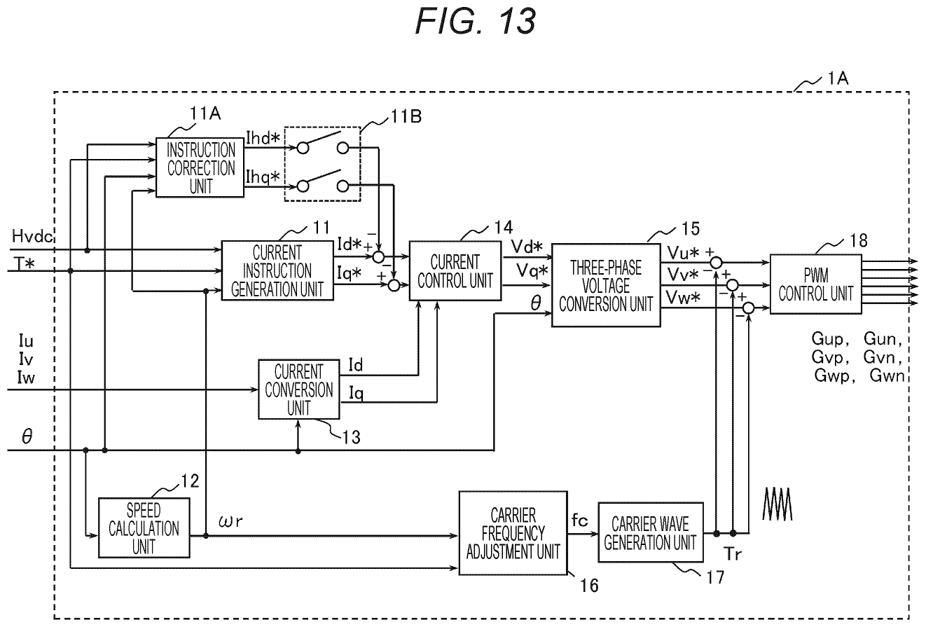

FIG. 13 is a block diagram showing a functional configuration of a motor control device 1A according to the second embodiment of the present invention. In FIG. 13, the motor control device 1A is identical in configuration with the motor control device 1 described in the first embodiment except that the motor control device 1A further includes an instruction correction unit 11A and a switching unit 11B.

The instruction correction unit 11A calculates a correction d-axis current instruction Ihd* and a correction q-axis current instruction Thq* for correcting the d-axis current instruction Id* and the q-axis current instruction Iq* generated by the current instruction generation unit 11, respectively. At this time, the instruction correction unit 11A calculates current instructions for superimposing pulsations following a given time order on the d-axis current instruction Id* and the q-axis current instruction Iq*, respectively, and outputs the results of the calculation as the correction d-axis current instruction Ihd* and the correction q-axis current instruction Ihq*. Details of a method by which the instruction correction unit 11A calculates the correction d-axis current instruction Ihd* and the correction q-axis current instruction Ihq will be described later.

The switching unit 11B switches a state of connection between the current instruction generation unit 11 and the instruction correction unit 11A. When the current instruction generation unit 11 is connected to the instruction correction unit 11A by the switching unit 11B, the correction d-axis current instruction Ihd* and the correction q-axis current instruction Ihq* outputted from the instruction correction unit 11A are superimposed on the d-axis current instruction Id* and the q-axis current instruction Iq* outputted from the current instruction generation unit 11, respectively. As a result, the d-axis current instruction Id* and the q-axis current instruction Iq* are corrected. The d-axis current instruction Id* and the q-axis current instruction Iq* that have been corrected in the above manner are inputted to the current control unit 14 and used for calculating the d-axis voltage instruction Vd* and the q-axis voltage instruction Vq*.

When the motor 2 is in the state of co-rotation drive and weak field control of the motor 2 is performed, the motor control device 1A of this embodiment causes the switching unit 11B to make a switching action in such a way as to connect the current instruction generation unit 11 to the instruction correction unit 11A. As a result, correction of the d-axis current instruction Id* and the q-axis current instruction Iq* is carried out.

The operation of the instruction correction unit 11A in the motor control device 1A will then be described. As described above, the instruction correction unit 11A determines the correction d-axis current instruction Ihd* and the correction q-axis current instruction Ihq* for superimposing the pulsations following the given time order on the d-axis current instruction Id* and the q-axis current instruction Iq*, respectively. At this time, the instruction correction unit 11A calculates the correction d-axis current instruction Ihd* and the correction q-axis current instruction Ihq* by adjusting the amplitude and the phase of the pulsations superimposed on the current instructions, based on the motor rotating speed or and the torque instruction T*, in such a way as to cancel vibrations and noise generated at the motor 2.

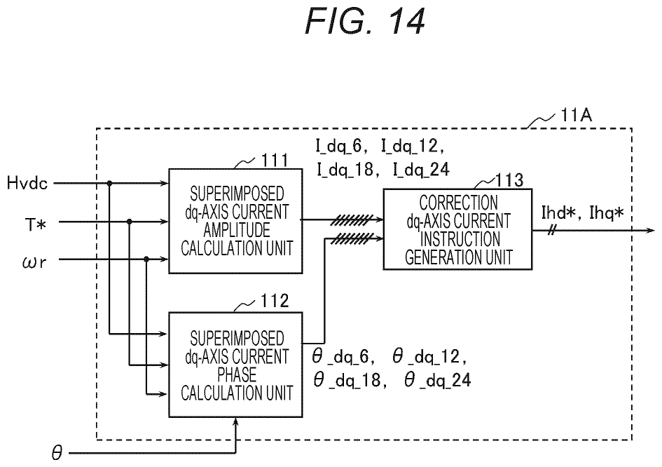

FIG. 14 is a block diagram of the instruction correction unit 11A according to the second embodiment of the present invention. The instruction correction unit 11A includes a superimposed dq-axis current amplitude calculation unit 111, a superimposed dq-axis current phase calculation unit 112, and a correction dq-axis current instruction generation unit 113.

The superimposed dq-axis current amplitude calculation unit 111 calculates the amplitude of the pulsation superimposed on each of the d-axis current instruction Id* and the q-axis current instruction Iq*, based on the torque instruction T*, the voltage Hvdc of the high-voltage battery 5, and the motor rotating speed or. In this embodiment, for example, for the motor 2 with 8 poles and 48 slots, the superimposed dq-axis current amplitude calculation unit 111 calculates the amplitude of the pulsation to be superimposed on the d-axis current instruction Id* and on the q-axis current instruction Iq* for each of time orders ranging from a time order 6 times an electrical angular frequency to a time order 24 times the same, that is, a time 6th order (rotation 24th order), a time 12th order (rotation 48th order), a time 18th order (rotation 72th order), and a time 24th order (rotation 96th order). In FIG. 14, the amplitudes of pulsations applied to the d-axis current instruction Id* and the amplitudes of pulsation applied to the q-axis current instruction Iq* are shown together for respective time orders. In other words, superimposed dq-axis current amplitudes Idq6, Idq12, Idq18, and Idq24 shown in FIG. 14 represent the amplitudes of pulsations applied to the d-axis current instruction Id* and to the q-axis current instruction Iq*in the 6th, 12th, 18th, and 24th time orders, respectively.

The superimposed dq-axis current phase calculation unit 112 calculates the phase of pulsation superimposed on each of the d-axis current instruction Id* and the q-axis current instruction Iq*, based on the torque instruction T*, the voltage Hvdc of the high-voltage battery 5, the motor rotating speed or, and the rotational position θ. In this embodiment, for example, for the motor 2 with 8 poles and 48 slots, the superimposed dq-axis current phase calculation unit 112 calculates the phase of the pulsation to be superimposed on the d-axis current instruction Id* and on the q-axis current instruction Iq* for each of time orders ranging from the time order 6 times the electrical angular frequency to the time order 24 times the same, that is, the time 6th order (rotation 24th order), the time 12th order (rotation 48th order), the time 18th order (rotation 72th order), and the time 24th order (rotation 96th order). In FIG. 14, the phases of pulsations applied to the d-axis current instruction Id* and the phases of pulsation applied to the q-axis current instruction Iq* are shown together for respective time orders. In other words, superimposed dq-axis current phases θdq6, θdq12, θdq18, and θdq24 shown in FIG. 14 represent the phases of pulsations applied to the d-axis current instruction Id* and to the q-axis current instruction Iq*in the 6th, 12th, 18th, and 24th time orders, respectively.

Based on the amplitude of a pulsation for each time order calculated by the superimposed dq-axis current amplitude calculation unit 111, that is, each of the superimposed dq-axis current amplitudes Idq6, Idq12, Idq18, and Idq24, and the phase of a pulsation for each time order calculated by the superimposed dq-axis current phase calculation unit 112, that is, each of the superimposed dq-axis current phases θdq6, θdq12, θdq18, and θdq24, the correction dq-axis current instruction generation unit 113 generates a superposition d-axis current instruction Ihd* and a superposition q-axis current instruction Ihq* corresponding to the pulsation.

The superposition d-axis current instruction Ihd* and the superposition q-axis current instruction Ihq*, which are generated by the correction dq-axis current instruction generation unit 113, are inputted to output ends of the current instruction generation unit 11 via the switching unit 11B, and these superposition d-axis current instruction Ihd* and superposition q-axis current instruction Ihq* are subtracted from the d-axis current instruction Id* and the q-axis current instruction Iq* that are generated by the current instruction generation unit 11, respectively. Hence the superposition d-axis current instruction Ihd* and superposition q-axis current instruction Thq* as pulsations corresponding to the rotation of the motor 2 are superimposed on the d-axis current instruction Id* and the q-axis current instruction Iq*, respectively. Then, obtained calculation results are inputted as the corrected d-axis current instruction Id* and q-axis current instruction Iq*, to the current control unit 14.

Calculation of the superimposed dq-axis current amplitudes Idq6, Idq12, Idq18, and Idq24 by the superimposed dq-axis current amplitude calculation unit 111 and calculation of the superimposed dq-axis current phases Odq6, Odq12, Odq18, and Odq24 by the superimposed dq-axis current phase calculation unit 112 can be carried out based on, for example, map information stored in advance. Each piece of map information can be created in advance by, for various combinations of the torque instruction T*, the voltage Hvdc of the high-voltage battery 5, and the motor rotating speed wr, obtaining in advance the amplitude or phase shift of a pulsation capable of effectively reducing iron loss caused at the motor 2 during weak field control for each time order through a simulation or measurement.

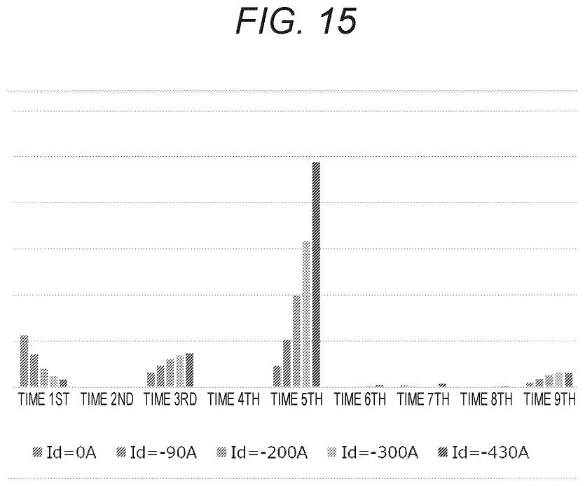

Next, reduction of iron loss during weak field control in this embodiment will be described. In the first embodiment, the method of reducing the system loss in the case where the motor 2 is in the state of co-rotation drive has been described for the motor 2 of which the modulation rate does not exceed 1.25 during traveling of the vehicle in many cases, as indicated in FIG. 6. However, in recent years, motors having a structure in which an induced voltage is improved to reduce motor loss per current are increasing. When such a motor is used as the motor 2 in the motor drive system 100 of FIG. 1, there is a possibility that the motor control method described in the first embodiment alone does not offer a sufficient effect for reducing the system loss. The reason for such possibility will be described below with reference to FIG. 15.

FIG. 15 depicts an example of an iron loss for each time order that results when a d-axis current Id is applied to the motor 2. Focusing on a relationship between the time order and the d-axis current Id reveals that when the d-axis current Id is set to 0A, a large amount of iron loss in the time 1st order develops. It also reveals that when the d-axis current Id is gradually increased from 0A, an iron loss in the time 5th order component increases as the iron loss in the time 1st order decreases because of a weak field effect caused by a flow of the d-axis current Id.

As described above, in the motor 2, the iron loss in the time 5th order component changes greatly under the influence of the weak field, and this leads to a conclusion that the iron loss during the weak field control can be suppressed by a pulsation current instruction for this time component (which is the time 6th order component in terms of the dq-axis). In other words, the iron loss increased by the weak field can be reduced by calculating in advance the amplitude and the phase of the 6th-order component of a dq-axis pulsation current through an electromagnetic field analysis and carrying out current control in pursuant to the current instruction corresponding to the dq-axis pulsation current.

In this embodiment, the above current control is implemented by the instruction correction unit 11A and the switching unit 11B that are described with reference to FIGS. 13 and 14. Specifically, when the motor 2 is under weak field control, the current instruction generation unit 11 is connected to the instruction correction unit 11A by the switching unit 11B, and the pulsation corresponding to the rotation of the motor 2 is superimposed on the d-axis current instruction Id* and the q-axis current instruction Iq*, using the superposition d-axis current instruction Ihd* and the superposition q-axis current instruction Thq* generated by the instruction correction unit 11A. Then, the corrected d-axis current instruction Id* and q-axis current instruction Iq* are inputted to the current control unit 14 and current control is carried. As a result, the PWM control unit 18 generates a PWM pulse signal capable of reducing the iron loss increased by the weak field.

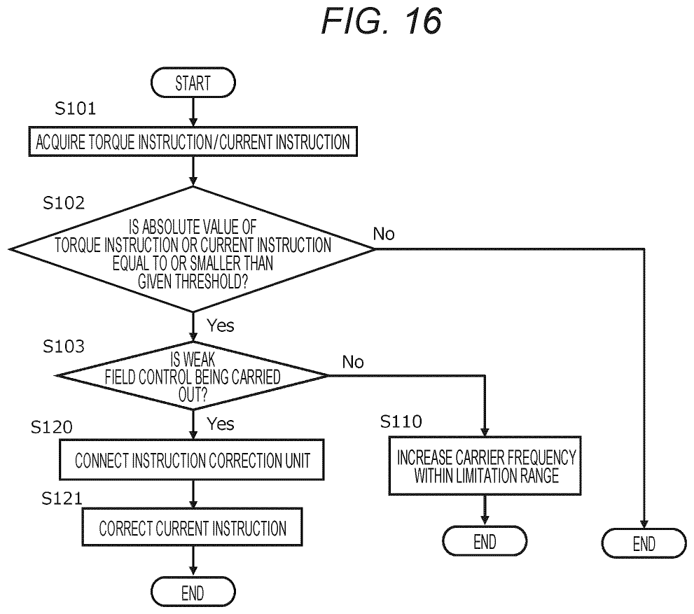

FIG. 16 is a flowchart showing a process by the instruction correction unit 11A, the switching unit 11B, and the carrier frequency adjustment unit 16 according to the second embodiment of the present invention. The process shown in the flowchart of FIG. 16 is executed by the instruction correction unit 11A, the switching unit 11B, and the carrier frequency adjustment unit 16, for example, in each given process cycle.

At steps S101 and S102, the same processes as described in the flowchart of FIG. 8 of the first embodiment are executed. In the process of step S102, when the absolute value of the torque instruction T* or the current instruction is equal to or smaller than the threshold, it is determined that the motor 2 is in the state of co-rotation drive, in which case the process flow proceeds to step S103. When the absolute value of the torque instruction T* or the current instruction is larger than the threshold, on the other hand, it is determined that the motor 2 is not in the state of co-rotation drive, in which case the process of the flowchart of FIG. 16 ends. In this case, the carrier frequency adjustment unit 16 adjusts the carrier frequency fc, based on the rotating speed or, in the same manner as does in normal synchronous PWM control.

At step S103, whether weak field control on the motor 2 is being executed is determined. When the PWM control unit 18 is executing the weak field control on the motor 2, the weak field control generating a PWM pulse signal to weaken magnetic flux of the motor 2, the process flow proceeds to step S120. Otherwise, the process flow proceeds to step S110.

When the process flow proceeds from step S103 to step S110, the carrier frequency fc, which is used in normal synchronous PWM control, is increased within the given limitation range in the same manner as in the flowchart of FIG. 8. In this case, in the same manner as in the first embodiment, the limitation range of the carrier frequency fc, the limitation range being determined based on, for example, the process load of the microcomputer serving as the motor control device 1A and on the capacity of the gate power supply that supplies power to the gate drive circuit 32 of the inverter 3, is saved by the motor control device 1A.

After adjustment of the carrier frequency fc at step S110, the process shown in the flowchart of FIG. 16 ends.

When the process flow proceeds from step S103 to step S120, on the other hand, the switching unit 11B makes a switching action to establish connection, thus connecting the instruction correction unit 11A to the output ends of the current instruction generation unit 11 at step S120.

At step S121, the instruction correction unit 11A carries out correction of a current instruction. In this process, as described above, the instruction correction unit 11A generates the superposition d-axis current instruction Ihd* and the superposition q-axis current instruction Ihq* and corrects the d-axis current instruction Id* and the q-axis current instruction Iq*, using these superposition d-axis current instruction Ihd* and superposition q-axis current instruction Ihq*, thus superimposing the pulsation corresponding to the rotation of the motor 2 on the d-axis current instruction Id* and the q-axis current instruction Iq*.

After correction of the current instruction at step S121, the process shown in the flowchart of FIG. 16 ends.

With reference to FIG. 16, the example in which the d-axis current instruction Id* and q-axis current instruction Iq* generated by the current instruction generation unit 11 are corrected by using the superposition d-axis current instruction Ihd* and superposition q-axis current instruction Ihq* generated by the instruction correction unit 11A has been described. However, instead of correcting the d-axis current instruction Id* and the q-axis current instruction Iq*, the d-axis voltage instruction Vd* and the q-axis voltage instruction Vq* generated by the current control unit 14 may be corrected. In this case, instead of generating the superposition d-axis current instruction Ihd* and the superposition q-axis current instruction Thq*, the instruction correction unit 11A generates a superposition d-axis voltage instruction Vhd* and a superposition q-axis voltage instruction Vhq* as voltage instructions for superposing pulsation following a given time order on the d-axis voltage instruction Vd* and on the q-axis voltage instruction Vq*. The superposition d-axis voltage instruction Vhd* and the superposition q-axis voltage instruction Vhq* can be generated based on, for example, map information stored in advance, in the same manner as the superposition d-axis current instruction Ihd* and the superposition q-axis current instruction Thq* are generated.

The above-described second embodiment of the present invention offers the following effects, in addition to the effects described in the first embodiment.

(9) The motor control device 1A includes the current instruction generation unit 11 that generates the d-axis current instruction Id* and the q-axis current instruction Iq*, based on the torque instruction T*, the current control unit 14 that calculates the d-axis voltage instruction Vd* and the q-axis voltage instruction Vq*, based on the d-axis current instruction Id* and the q-axis current instruction Iq*, and the instruction correction unit 11A that corrects the d-axis current instruction Id* and the q-axis current instruction Iq* or the d-axis voltage instruction Vd* and the q-axis voltage instruction Vq* so that a harmonic component of a specific order is superimposed on a current flowing through the motor 2. The PWM control unit 18 can carry out weak field control by which a PWM pulse signal is generated in such a way as to weaken the magnetic flux of the motor 2. When the motor 2 is in the state of co-rotation drive (step S102: Yes) and the PWM control unit 18 is carrying out weak field control (step S103: Yes), the instruction correction unit 11A corrects the d-axis current instruction Id* and the q-axis current instruction Iq* or the d-axis voltage instruction Vd* and the q-axis voltage instruction Vq* (step S121). When the PWM control unit 18 is not carrying out weak field control (step S103: No), the carrier frequency adjustment unit 16 adjusts the carrier frequency fc so that the carrier frequency fc in the case where the motor 2 is in the state of co-rotation drive becomes higher than the carrier frequency fc in the case where the motor 2 is not in the state of co-rotation drive (step S110). Because of this configuration, the power loss that develops at the time of driving the motor can be sufficiently reduce in both of the case where the motor 2 is in the state of co-rotation drive and in the case where the motor 2 is not in the state of co-rotation drive and at the same time, the iron loss during weak field control can be reduced.

(10) The above specific order is a multiple of 6 in terms of electrical angle, which is, for example, the 6th order, the 12th order, the 18th order, or the 24th order. Because of this, among iron loss components corresponding respectively to time orders, the iron loss components developing when the d-axis current Id is applied to the motor 2, an iron loss component of a specific time order that is changed greatly by the weak field can be reduced effectively.

In the first and second embodiments described above, the examples in which the motor control devices 1 and 1A control drive of the motor 2, based on the incoming torque instruction I* from the outside, have been described. However, drive of the motor 2 may be controlled based not on the torque instruction T* but on, for example, an accelerator instruction corresponding to operation of an accelerator pedal made by the driver of the vehicle or a torque instruction outputted from an autonomous driving control device that carries out autonomous driving control of the vehicle.

In the first and second embodiments described above, when the absolute value of the torque instruction T* is equal to or smaller than the given threshold and the d-axis current instruction Id* and the q-axis current instruction Iq* outputted from the current instruction generation unit 11 can be regarded as substantially 0, output of the PWM pulse signal from the motor control devices 1 and 1A to the inverter 3 may be stopped. By doing this, a current that flows in the motor 2 when it is in the state of co-rotation drive is rectified by a diode, which allows further reduction of the system loss.

In another case, in the first and second embodiments described above, a circuit breaker may be disposed between the inverter 3 and the motor 2, and when the absolute value of the torque instruction T* is equal to or smaller than the given threshold and the d-axis current instruction Id* and the q-axis current instruction Iq* outputted from the current instruction generation unit 11 can be regarded as substantially 0, this circuit breaker is opened to disconnect the inverter 3 from the motor 2. In this configuration, no current flows through the motor 2 when it is in the state of co-rotation drive, which minimizes the system loss.

### Third Embodiment

A third embodiment of the present invention will then be described with reference to drawings.

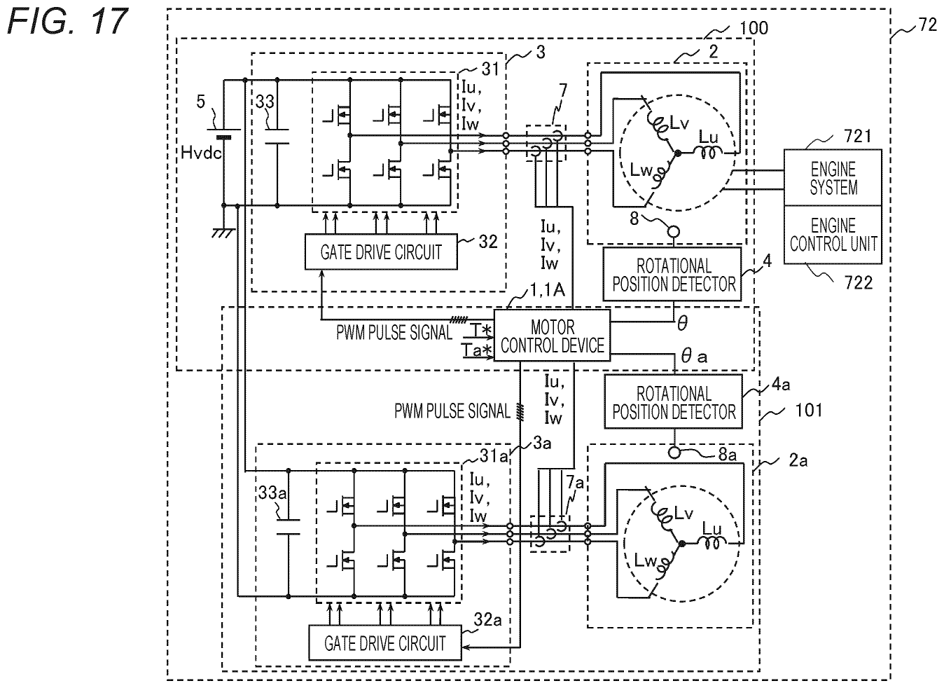

FIG. 17 is a configuration diagram of a hybrid system 72 according to the third embodiment of the present invention.

As shown in FIG. 17, the hybrid system 72 includes the motor drive system 100 (the motor control device 1 or 1A, the motor 2, the inverter 3, the rotational position detector 4, the high-voltage battery 5, the current detection unit 7) described in the first and second embodiments, and a motor drive system 101 (the motor control device 1 or 1A, a motor 2a, an inverter 3a, a rotational position detector 4a, the high-voltage battery 5, a current detection unit 7a) similar to the motor drive system 100. The motor drive systems 100 and 101 share the high-voltage battery 5 and the motor control device 1 or 1A.

The motor 2a is fitted with a rotational position sensor 8a that detects a rotational position θa of the rotor. The rotational position detector 4a calculates the rotational position θa from an incoming signal from the rotational position sensor 8a, and outputs the rotational position θa to the motor control device 1 or 1A. The current detection unit 7a is disposed between the inverter 3a and the motor 2a. A torque generated at the rotor of the motor 2a is transmitted from a rotating shaft fixed to the rotor, to outside of the motor drive system 101.

The inverter 3a includes an inverter circuit 31a, a gate drive circuit 32a, and a smoothing capacitor 33a. The gate drive circuit 32a is connected to the motor control device 1 or 1A to which the gate drive circuit 32 of the inverter 3 is connected as well for shared use, and generates gate drive signals for controlling switching elements included in the inverter circuit 31a, based on an incoming PWM pulse signal from the motor control device 1 or 1A, and outputs the gate drive signals to the inverter circuit 31a. The inverter circuit 31a and the smoothing capacitor 33a are connected to the high-voltage battery 5 to which the inverter circuit 31 and the smoothing capacitor 33 are connected as well for shared use.

The torque instruction T* for the motor 2 and a torque instruction Ta* for the motor 2a are inputted to the motor control device 1 or 1A. Based on these torque instructions, the motor control device 1 or 1A generates PWM pulse signals for controlling drive of the motors 2 and 2a by the method described in the first embodiment or the second embodiment, and outputs the PWM pulse signals to the inverters 3 and 3a, respectively. Specifically, the carrier frequency adjustment unit 16 included in the motor control device 1 or 1A adjusts the carrier frequency fc so that the carrier frequency fc in the case where the motors 2 and 2a are in the state of co-rotation drive becomes higher than the carrier frequency fc in the case where the motors 2 and 2a are not in the state of co-rotation drive. This reduces the system loss. The carrier frequency adjustment unit 16 may set the carrier frequency fc of a different value for each of the motors 2 and 2a.

To the motor 2, an engine system 721 and an engine control unit 722 are connected. The engine system 721 runs under control by the engine control unit 722, and causes the motor 2 to rotate. The motor 2, which is caused to rotate by the engine system 721, works as a generator to generate AC power. AC power generated by the motor 2 is converted by the inverter 3 into DC power, which is supplied to the high-voltage battery 5 to charge it. As a result, the hybrid system 72 can function as a series hybrid system. The engine system 721 and the engine control unit 722 may be connectable to the motor 2a.

According to this embodiment, by providing the hybrid system 72 of FIG. 17, using the motor control device 1 or the motor control device 1A described in the first and second embodiments, the effect of reducing the system loss can be achieved in each of the motor drive system 100 and the motor drive system 101 in the same manner as described in the first and second embodiments.

### Fourth Embodiment

A fourth embodiment of the present invention will then be described with reference to drawings.

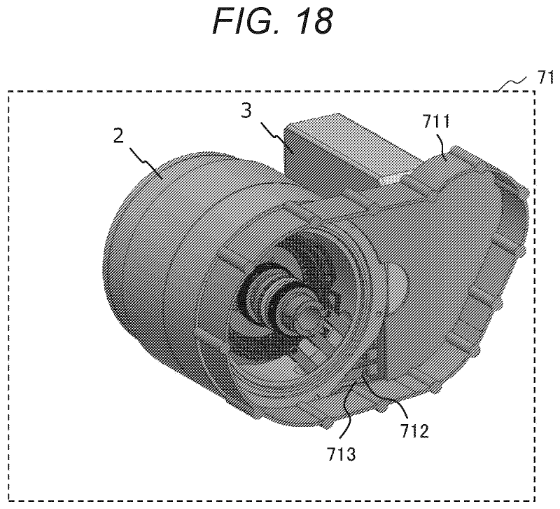

FIG. 18 is an external perspective view of a mechanically and electrically integrated unit 71 according to the fourth embodiment of the present invention. The mechanically and electrically integrated unit 71 includes the motor drive system 100 (the motor control device 1 or 1A, the motor 2, and the inverter 3) described in the first and second embodiments. The motor 2 and the inverter 3 are coupled via a bus bar 712 at a coupling portion 713. Output from the motor 2 is transmitted to a differential gear (not illustrated) via a gear 711 and is further transmitted to an axle. The motor control device 1 or 1A, which is not shown in FIG. 18, can be disposed at any given position.

The mechanically and electrically integrated unit 71 is characterized by its structure in which the motor 2, the inverter 3, and the gear 711 are integrated together. The mechanically and electrically integrated unit 71 is required to reduce a system loss given by summing up losses caused by the motor 2 and the inverter 3. To meet this requirement, the system loss is reduced by using the motor control device 1 or motor control device 1A described in the first and second embodiments. Hence the mechanically and electrically integrated unit with high efficiency can be provided.

### Fifth Embodiment

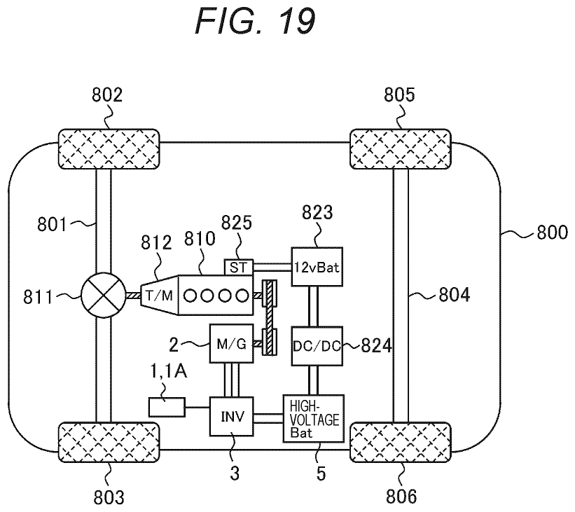

An embodiment in which the motor drive system 100 described in the first embodiment is applied to a vehicle will then be described with reference to FIG. 19.

FIG. 19 is a configuration diagram of a hybrid car system according to a fifth embodiment of the present invention. As shown in FIG. 19, the hybrid car system of this embodiment has a power train in which the motor 2 works as a motor/generator.

In the hybrid car system shown in FIG. 19, a front wheel axle 801 is pivotally supported on a front part of a vehicle body 800 to allow the front wheel axle 801 to rotate, and front wheels 802 and 803 are fitted to both ends of the front wheel axle 801, respectively. On a rear part of the vehicle body 800, a rear wheel axle 804 is pivotally supported to allow it to rotate, and rear wheels 805 and 806 are fitted to both ends of the rear wheel axle 804, respectively.

The central part of the front wheel axle 801 is fitted with a differential gear 811, which is a power distribution mechanism. This differential gear 811 operates in such a way as to distribute a rotational driving force transmitted from the engine 810 via a transmission 812, to the left and right parts of the front wheel axle 801.

A pulley attached to a crankshaft of the engine 810 and a pulley attached to a rotating shaft of the motor 2 are mechanically coupled via a belt.

As a result, a rotational driving force of the motor 2 can be transmitted to the engine 810 as a rotational driving force of the engine 810 can be transmitted to the motor 2. At the motor 2, three-phase AC power outputted from the inverter 3 according to control by the motor control device 1 or 1A is supplied to the stator coil of the stator, which rotates the rotor, thus generating the rotational driving force corresponding to the three-phase AC power.

In other words, the motor 2 operates as an electric motor using three-phase AC power outputted from the inverter 3 according to control by the motor control device 1 and 1A, and at the same time, operates also as a generator that generates three-phase AC power when the rotor receiving the rotational driving force of the engine 810 rotates to induce an electromotive force in the stator coil of the stator.

The inverter 3 is a power conversion device that converts DC power supplied from the high-voltage battery 5, which is a high-voltage (42 V or 300 V) power supply, into three-phase AC power. The inverter 3 controls a three-phase AC current flowing through the stator coil of the motor 2, according to an operation instruction value and the magnetic pole position of the rotor.

Three-phase AC power generated by the motor 2 is converted by the inverter 3 into DC power, which is supplied to the high-voltage battery 5 to charge it. The high-voltage battery 5 is electrically connected to a low-voltage battery 823 via a DC-DC converter 824. The low-voltage battery 823 serves as a low-voltage (14 V) power supply of the car, and is used to supply power to a starter 825 for starting (cold-starting) the engine 810, a radio, lights, and the like.

When the vehicle is stopped to wait for traffic light switching or the like (idle stop mode), the engine 810 is stopped. Then, when the engine 810 is restarted (hot-start) at restart running the vehicle, the motor 2 is driven by the inverter 3 to restart the engine 810. In the idle stop mode, if charging of the high-voltage battery 5 is insufficient or the engine 810 is not warmed up sufficiently, the engine 810 is not stopped but is kept running. In addition, during the idle stop mode, a drive source for auxiliary equipment driven by the engine 810, such as a compressor of an air conditioner, needs to be secured. In this case, the motor 2 is driven to drive the auxiliary equipment.

Likewise, in an acceleration mode or a high-load operation mode, the motor 2 is driven to assist the engine 810 in providing driving power. Conversely, in a charging mode in which the high-voltage battery 5 needs to be charged, the engine 810 causes the motor 2 to generate power, with which the high-voltage battery 5 is charged. In other words, a regeneration mode is executed, the regeneration mode starting at braking or deceleration of the vehicle.

In the hybrid car system of FIG. 19 provided by using the motor drive system 100 described in the first and second embodiments, the motor control device 1 or 1A adjusts the carrier frequency fc so that the carrier frequency fc in the case where the motor 2 is in the state of co-rotation drive becomes higher than the carrier frequency fc in the case where the motor 2 is not in the state of co-rotation drive. This makes system loss reduction possible.

In each of the embodiments described above, constituent elements in the motor control devices 1 and 1A (FIG. 2 and FIG. 13) may not be hardware-based constituent elements but may be constituent elements (functions) each provided by a program run by the CPU. In a case where constituent elements in the motor control devices 1 and 1A are each provided by a program run by the CPU, the number of pieces of hardware is reduced, which offers an advantage of lower cost. In addition, such a program can be stored in advance in a storage medium of the motor control device and is provided. Alternatively, the program may be stored in an independent storage medium and is provided or may be recorded and stored in the storage medium of the motor control device. Further, the program may be provided as a computer-readable computer program product of various forms, such as data signals (carrier waves).

The present invention is not limited to the above-described embodiments and may be modified into various forms within a range not departing from the subject of the present invention.

### REFERENCE SIGNS LIST

1, 1A motor control device
2 motor
3 inverter
4 rotational position detector
5 high-voltage battery
7 current detection unit
8 rotational position sensor
11 current instruction generation unit
11A instruction correction unit
11B switching unit
12 speed calculation unit
13 current conversion unit
14 current control unit
15 three-phase voltage conversion unit
16 carrier frequency adjustment unit
17 carrier wave generation unit
18 PWM control unit
31 inverter circuit
32 gate drive circuit
33 smoothing capacitor
71 mechanically and electrically integrated unit
72 hybrid system
100, 101 motor drive system
711 gear
712 bus bar
713 coupling portion
800 vehicle body
801 front wheel axle
802 front wheel
803 front wheel
804 rear wheel axle
805 rear wheel
806 rear wheel
810 engine
811 differential gear
812 transmission
823 low-voltage battery
824 DC-DC converter
825 starter

1. A motor control device connected to an inverter that converts DC power into AC power and that outputs the AC power to a motor, the motor control device controlling operation of the inverter according to a torque instruction, thereby controlling drive of the motor, using the inverter, the motor control device comprising:
a carrier wave generation unit that generates a carrier wave;
a carrier frequency adjustment unit that adjusts a carrier frequency that is a frequency of the carrier wave; and
a PWM control unit that performs pulse width modulation of a voltage instruction, using the carrier wave, to generate a PWM pulse signal for controlling operation of the inverter,
wherein the carrier frequency adjustment unit adjusts the carrier frequency so that the carrier frequency in a case where the motor is in a state of co-rotation drive becomes higher than the carrier frequency in a case where the motor is not in the state of co-rotation drive.

2. The motor control device according to claim 1, wherein the carrier frequency adjustment unit compares an absolute value of the torque instruction with a given threshold, and when the absolute value of the torque instruction is equal to or smaller than the threshold, determines that the motor is in a state of co-rotation drive.

3. The motor control device according to claim 2, wherein the threshold is determined based on a result of an electromagnetic field analysis simulation or an experiment conducted in advance.

4. The motor control device according to claim 2, wherein when the absolute value of the torque instruction is equal to or smaller than the threshold, the motor control device stops outputting the PWM pulse signal to the inverter.

5. The motor control device according to claim 2, wherein when the absolute value of the torque instruction is equal to or smaller than the threshold, the motor control device disconnects the inverter from the motor.

6. The motor control device according to claim 1, wherein the carrier frequency in a case where the motor is in a state of co-rotation drive is determined based on at least either a process load of the motor control device or a capacity of a gate power supply that supplies power to a gate drive circuit included in the inverter.

7. The motor control device according to claim 1, wherein the motor control device controls drive of the motor so that an induced voltage generated by rotation of the motor is smaller than a withstand voltage of a switching element of the inverter.

8. The motor control device according to claim 1, comprising a current control unit that calculates the voltage instruction in every given calculation cycle,
wherein the carrier frequency adjustment unit adjusts the carrier frequency in a case where the motor is in a state of co-rotation drive such that the calculation cycle is longer than half of a cycle of the carrier wave.

9. The motor control device according to claim 1, wherein the carrier frequency adjustment unit adjusts the carrier frequency so that a rate of change of the carrier frequency is equal to or smaller than a given value.

10. The motor control device according to claim 1, comprising:
a current instruction generation unit that generates a current instruction based on the torque instruction;
a current control unit that calculates the voltage instruction, based on the current instruction; and
an instruction correction unit that corrects the current instruction or the voltage instruction so that a harmonic component of a specific order is superimposed on a current flowing through the motor,
wherein
the PWM control unit carries out weak field control by which the PWM pulse signal is generated in such a way as to weaken magnetic flux of the motor,
when the motor is in a state of co-rotation drive and the PWM control unit is carrying out the weak field control, the instruction correction unit corrects the current instruction or the voltage instruction, and
when the PWM control unit is not carrying out the weak field control, the carrier frequency adjustment unit adjusts the carrier frequency so that the carrier frequency in a case where the motor is in the state of co-rotation drive becomes higher than the carrier frequency in a case where the motor is not in the state of co-rotation drive.

11. The motor control device according to claim 10, wherein the specific order is an order of a multiple of 6 in terms of an electrical angle.

12. A motor control device connected to an inverter that converts DC power into AC power and that outputs the AC power to a motor, the motor control device controlling operation of the inverter according to a torque instruction, thereby controlling drive of the motor, using the inverter, wherein
when an absolute value of the torque instruction is equal to or smaller than a given threshold, the motor control device generates a PWM pulse signal for controlling operation of the inverter so that harmonic pulsation of a gap magnetic flux density between a stator and a rotor of the motor is suppressed.

13. A hybrid system comprising:
the motor control device according to claim 1;
the inverter connected to the motor control device;
the motor driven by the inverter; and
an engine system connected to the motor.

14. A mechanically and electrically integrated unit comprising:
the motor control device according to claim 1;
the inverter connected to the motor control device;
the motor driven by the inverter; and
a gear that transmits a rotational driving force of the motor,
wherein the motor, the inverter, and the gear are put together into an integrated structure.

15. An electric vehicle system comprising:
the motor control device according to claim 1;
the inverter connected to the motor control device; and
the motor driven by the inverter,
wherein the electric vehicle system travels by using a rotational driving force of the motor.
